(19) United States
(12) Patent Application Publication
(10) Pub. No.: US 2025/0173636 A1
(43) Pub. Date: May 29, 2025

(54) MULTI-PARTY RESTAURANT DINING MEAL KIT ORDERING AND PREPARATION SYSTEM

(71) Applicants: Desiree Vazquez, Grand Rapids, MI (US); John Hibma, Grand Rapids, MI (US)

(72) Inventors: Desiree Vazquez, Grand Rapids, MI (US); John Hibma, Grand Rapids, MI (US)

(21) Appl. No.: 18/746,158

(22) Filed: Jun. 18, 2024

Related U.S. Application Data
(60) Provisional application No. 63/603,085, filed on Nov. 27, 2023.

(51) Int. Cl. G06Q 10/0631; G06Q 50/12

(52) U.S. Cl. CPC G06Q 10/0631; G06Q 50/12

(57) ABSTRACT

This specification discloses a multi-party restaurant dining meal kit ordering and preparation system where the customer party may select a meal, a meal kit provider, a schedule for dining, and a restaurant to prepare and serve the meal at the restaurant to the customer or to another consumer. The customer party may choose another party for scheduling.

### CROSS-REFERENCE TO RELATED APPLICATIONS

This application claims the benefit under 35 U.S.C. § 119(e) of U.S. Provisional Application No. 63/603,085 entitled “MULTI-PARTY RESTAURANT DINING MEAL KIT ORDERING AND PREPARATION SYSTEM,” filed on Nov. 27, 2023, the entire disclosure of which, except for any definitions, disclaimers, disavowals, and inconsistencies, is incorporated herein by reference.

### BACKGROUND

The present disclosure generally relates to food ordering, dining, and delivery systems. In particular, the present disclosure relates to the process of ordering, delivering, and preparing meal kits. Meal kits are useful to consumers for simplifying recipe selections, achieving dietary goals, planning meals, and purchasing ingredients.

In a typical example in the field of meal kit systems, a customer party A places orders for meal kits from a meal kit provider party B. These orders are delivered on a regular schedule, for example, a weekly delivery of one to twenty meals following an ad hoc schedule as determined between the parties. Following that schedule, the meal kit provider party B delivers one or more meal kits to the customer party A's location. The standard industry practice is that customer party A receives the meal, prepares the meal, and dines on the meal at customer A's location.

Existing meal kit systems suffer from problems, including at least the following. Some customers lack the interest, time, tools, or expertise to prepare the meal kits. Some customers do not store or prepare the food contents of the meal kit before the food contents spoil or the next food kit arrives. Assuming preparation does occur, some customers do not consume the entire meal kit before the food content spoils or the next food kit arrives. Consumers lack the ability to enjoy the selected and prepared meal in a restaurant setting. As a result of one or more of these problems, the quality of the food ingredients is marginalized, the quality of the resulting recipe is compromised, the customers waste the time that the customers spent ordering the meal kit, the customers waste the food that was contained in the meal kit, the customers waste the resources spent on the meal kit logistics, and the customers are dissatisfied. Current meal kit systems do not address these problems satisfactorily.

U.S. patent application Ser. No. 15/619,437 (Ibrahim) discloses providing healthy affordable homemade parties, events, meetings, food, meals, recipes and/or drinks instead of going to expensive restaurants. However, in Ibrahim there are no provisions for customer party A selecting the ingredients and recipe from meal kit provider party B, and customer party A also selecting a separate meal preparation and service provider restaurant party C to provide a dining experience in a restaurant setting.

U.S. patent application Ser. No. 17/610,379 (Nartowicz) discloses a computer-based data-exchange system for distributing perishable items. However, in Nartowicz there are no provisions for customer party A selecting the ingredients and recipe from meal kit provider party B, and customer party A also selecting a separate meal preparation and service provider restaurant party C to provide a dining experience in a restaurant setting.

U.S. patent application Ser. No. 16/796,938 (Sablak) discloses a software application-based method for managing a marketplace of homemade foods provides a system for connecting consumers with local chefs. However, in Sablak there are no provisions for customer party A selecting the ingredients and recipe from meal kit provider party B, and customer party A also selecting a separate meal preparation and service provider restaurant party C to provide a dining experience in a restaurant setting.

U.S. patent application Ser. No. 16/044,663 (Chase et. al.) discloses a virtual restaurant system providing centrally managed food ordering, production, and delivery of branded food items normally only available from different restaurant menus. However, in Chase et. al. there are no provisions for customer party A selecting the ingredients and recipe from meal kit provider party B, and customer party A also selecting a separate meal preparation and service provider restaurant party C to provide a dining experience in a restaurant setting.

U.S. patent application Ser. No. 12/351,773 (Antonellis) discloses a system that optimizes resources in the order fulfillment process based on a means of determining customer party A's geo-location, such as a global positioning system, cellular tower triangulation system, or a system reading the location of an RFID tag. However, in Antonellis there are no provisions for customer party A selecting the ingredients and recipe from meal kit provider party B, and customer party A also selecting a separate meal preparation and service provider restaurant party C to provide a dining experience in a restaurant setting.

U.S. Pat. No. 10,445,842 (Thompson) discloses a system that receives customer party A's order, specifically a consumer at a sporting facility such as a golf course, and the service provider restaurant party C delivering the food to the tracked position of the customer party A. However, in Thompson there are no provisions for customer party A selecting the ingredients and recipe from meal kit provider party B, and customer party A also selecting service provider restaurant party C to provide a dining experience in a restaurant setting.

U.S. Pat. No. 6,026,375 (Hall et al.) discloses a system that receives customer party A's order, for example for ski-lift lines, and customer party A's location information from a location determination system. The service provider restaurant party C uses the customer party A's location to determine any of several local facilities, for example ski resorts, that can satisfy the customer party A's order. However, in Hall there are no provisions for customer party A selecting the ingredients and recipe from meal kit provider party B, and customer party A also selecting a service provider restaurant party C to provide a dining experience in a restaurant setting.

Therefore, there is a need for an improved meal kit service system that solves at least the above-identified problems. It would also be desirable to provide a meal kit service system which can be more easily ordered, utilized, implemented, and consumed by the consumer, with a dining experience in a restaurant setting.

### SUMMARY OF THE INVENTION

The disclosure is a meal kit service system which addresses the above-mentioned problems of food ordering, scheduling, waste, dissatisfaction, and other problems.

Examples of the first aspect of the disclosure may include any one or a combination of the following processes:
the customer party A, who
a. may select a meal kit provider party B,
b. may select a meal preparation service provider restaurant party C,
c. may order at least one meal kit, including ingredients and a recipe, from the meal kit provider party B, and
d. may schedule a time period for the preparation and consumption of the meal at the location of the meal preparation service provider restaurant party C;
the meal kit provider party B, who
a. may order the ingredients for at least one meal kit, and
b. may deliver the ingredients for the at least one meal kit to the meal preparation service provider restaurant party C;
the meal preparation service provider restaurant party C, who
a. may receive the at least one meal kit, including ingredients and recipe, from meal kit provider party B,
b. may prepare the meal from the meal kit ingredients according to the meal kit recipe;
c. may serve the meal to the customer party A and/or consumer party E at the meal preparation service provider restaurant party C;
the scheduling party D, who
a. may coordinate and communicate the details for the dining experience among the parties, and
the consumer party E, who
a. as an alternative or an addition to customer party A, may consume the meal at the meal preparation service provider restaurant party C.

Optionally, at least one party taking on the processes of one or more other parties.

### BRIEF DESCRIPTION OF DRAWINGS

FIG. 1 illustrates a flow chart view of an example of a multi-party restaurant dining meal kit ordering and preparation system according to one aspect of the present disclosure.

FIG. 2 illustrates a flow chart view of another example of a multi-party restaurant dining meal kit ordering and preparation system according to one aspect of the present disclosure.

FIG. 3 illustrates a flow chart view of another example of a multi-party restaurant dining meal kit ordering and preparation system according to one aspect of the present disclosure.

FIG. 4 illustrates a flow chart view of another example of a multi-party restaurant dining meal kit ordering and preparation system according to one aspect of the present disclosure.

FIG. 5 illustrates a flow chart view of another example of a multi-party restaurant dining meal kit ordering and preparation system according to one aspect of the present disclosure.

FIG. 6 illustrates a flow chart view of another example of a multi-party restaurant dining meal kit ordering and preparation system according to one aspect of the present disclosure.

FIG. 7 illustrates a flow chart view of another example of a multi-party restaurant dining meal kit ordering and preparation system according to one aspect of the present disclosure.

### DETAILED DESCRIPTION

In the following description, for the purposes of explanation, various specific details are set forth in order to provide a thorough understanding of examples of the present disclosure. It will be apparent, however, that examples of the present disclosure may be practiced without these specific details. Several described features can each be used independently of one another or with any combination of other features. An individual feature may address only some of the problems discussed above.

The ensuing description provides exemplary examples only and is not intended to limit the scope, applicability, or configuration of the disclosure. Rather, the ensuing description of the exemplary examples will provide those skilled in the art with an enabling description for implementing an exemplary example. Various changes may be made in the function and arrangement of elements without departing from the spirit and scope of the present disclosure.

Specific details are given in the following description to provide a thorough understanding of the examples. However, it will be understood by one of ordinary skill in the art that the examples may be practiced without these specific details. For example, process steps, customers, consumers, meal kit suppliers, transportation providers, information, and other components may be shown as components in block diagram form in order not to obscure the examples in unnecessary detail. In other instances, well-known processes, algorithms, structures, and techniques may be shown without unnecessary detail in order to avoid obscuring the examples.

Also, it is noted that individual examples may be described as a process which is depicted as a flowchart, a flow diagram, a data flow diagram, a structure diagram, or a block diagram. Although a flowchart or a method may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, and anything similar. When a process corresponds to a function, its termination can correspond to a return of the function to the calling function or the main function.

The following terms may be used in the disclosure and may include the meaning as per the indicative definition provided below.

The term “meal kit” includes the recipe for the meal, the ingredients for the meal, or both the recipe and the ingredients for the meal.

The term “exemplary” and/or “demonstrative” is used to mean serving as an example, instance, or illustration. For the avoidance of doubt, the subject matter disclosed is not limited by such examples. Any aspect or design described as “exemplary” and/or “demonstrative” is not necessarily to be construed as preferred or advantageous over other aspects or designs, nor is it meant to preclude equivalent exemplary structures and techniques known to those of ordinary skill in the art. To the extent that the terms “includes,” “has,” “contains,” and other similar words are used in either the detailed description or the claims, such terms are intended to be inclusive, in a manner similar to the term “comprising” as an open transition word, without precluding any additional or other elements.

Reference throughout this specification to “one example,” “an example,” “an instance,” or “one instance” means that a particular feature, structure, or characteristic described in connection with the example is included in at least one example of the present disclosure. The appearances of the phrases “in one example” or “in an example” in various places throughout this specification are not necessarily all referring to the same example. Further, the features, structures, or characteristics may be combined in any suitable manner in one or more examples.

The terminology used is for the purpose of describing examples only and is not intended to be limiting of the present disclosure. The singular forms “a,” “an,” and “the” are intended to include the plural forms as well, unless the context clearly indicates otherwise. The terms “comprises” and/or “comprising,” specify the presence of stated features, integers, steps, operations, elements, and/or components, but do not preclude the presence or addition of one or more other features, integers, steps, operations, elements, components, and/or groups of these. The term “and/or” includes any and all combinations of one or more of the associated listed items.

The disclosed examples of the multi-party restaurant dining meal kit preparation system propose solutions to address the above-mentioned problems. For example, the customer party A selects the ingredients and recipe from meal kit provider party B, customer party A also selects meal preparation service provider restaurant party C, and customer party A selects the schedule. The customer party A gets to enjoy the selected recipe and the prepared meal in a restaurant setting without the additional burdens of receiving the food, protecting the food from spoilage, and preparing the food. The food is not wasted and the customer party A is satisfied. Some but not all of the numerous advantages of the disclosed examples are listed in this disclosure.

Examples of a method for providing a multi-party restaurant dining meal kit preparation system are disclosed. The accompanying drawings incorporated in this disclosure constitute a part of the disclosure. Large black arrows may represent the process flow, material flow, and/or communication from one party to another party. For illustrative purposes, the disclosed examples are organized into columns to demonstrate which party, listed at the top of each column, may take the steps listed in that column. Each step may also be taken by one or more other parties. The drawings illustrate exemplary examples of the disclosed methods and systems in which like reference numerals refer to the same parts throughout the different drawings. Components in the drawings are not necessarily to scale. Instead, the emphasis is to clearly illustrate the principles of the disclosure. Some drawings may indicate the elements using block diagrams and may not represent the entire disclosure. It will be appreciated by those skilled in the art that disclosure of such drawings includes the disclosure of the various parties, information, food contents, and processes used to implement such methods and systems. These and other features, aspects, and advantages of the present disclosure will become better understood with regards to the following and ensuing description, appended claims, and accompanying drawings where:

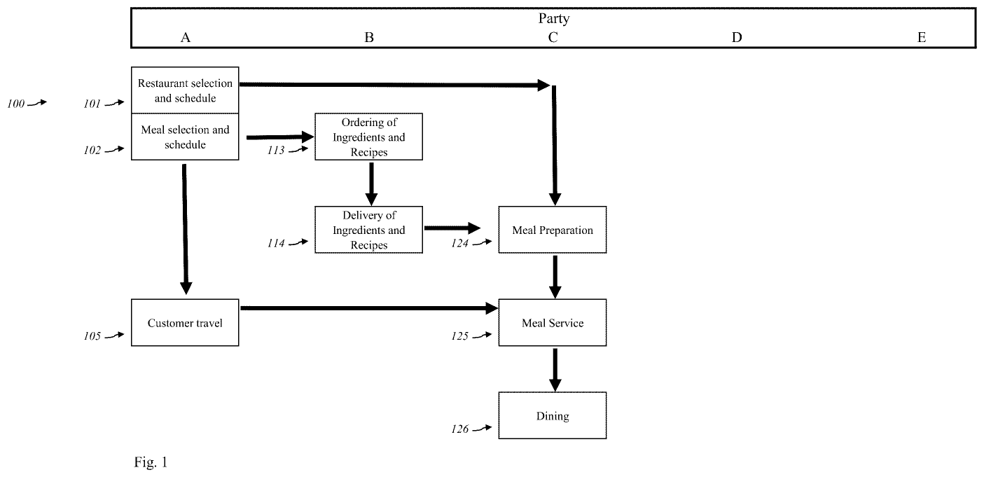

FIG. 1 illustrates a flow chart view of the preferred example of a multi-party restaurant dining meal kit preparation system 100 according to one aspect of the present disclosure. Customer party A may select 101 a meal preparation service provider restaurant party C and may select 101 a schedule for dining 126 at meal preparation service provider restaurant party C, and may communicate the meal kit and schedule information to meal preparation service provider restaurant party C. Customer party A may select 102 a meal and a schedule, and may communicate the meal and schedule to meal kit company party B. Meal kit company party B may order 113 the meal kit ingredients and may deliver 114 those meal kit recipe and ingredients to meal preparation service provider restaurant party C per the schedule. Meal preparation service provider restaurant party C may prepare 124 the meal kit per the recipe per the schedule. Also per the schedule, customer party A may travel 105 to meal preparation service provider restaurant party C for meal service 125 of the prepared meal and where customer party A partakes in dining 126 on the prepared meal.

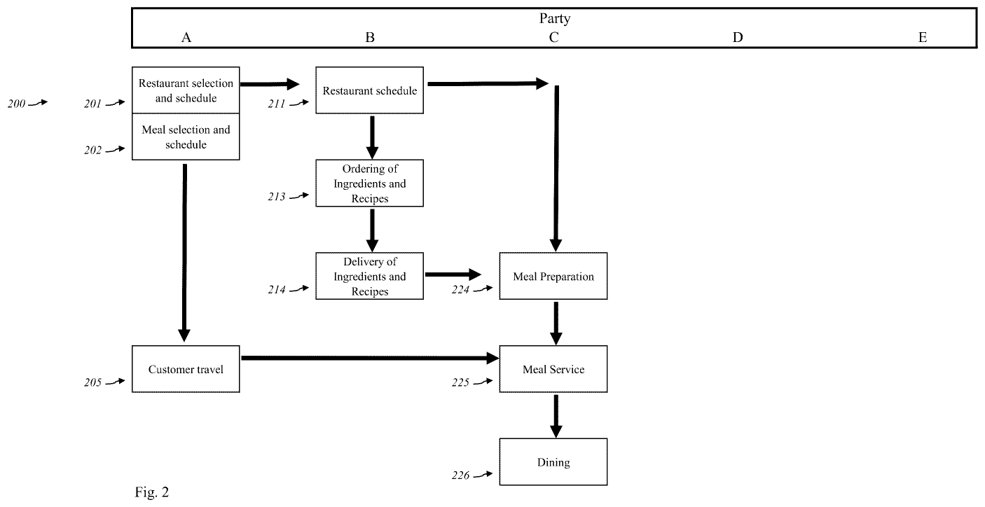

FIG. 2 illustrates a flow chart view of another example of a multi-party restaurant dining meal kit preparation system 200 according to one aspect of the present disclosure. Customer party A may select 201 a meal preparation service provider restaurant party C for preparation of the meal and may select 201 a schedule for dining 226 at meal preparation service provider restaurant party C, and may communicate the meal and schedule information to meal kit company party B. Customer party A may select 202 a meal and a schedule, and may communicate the meal and schedule to meal kit company party B. Meal kit company party B may communicate 211 the meal, the restaurant, and the schedule information to meal preparation service provider restaurant party C. Meal kit company party B may order 213 the meal kit ingredients and may deliver 214 those meal kit recipe and ingredients to meal preparation service provider restaurant party C per the schedule. Meal preparation service provider restaurant party C may prepare 224 the meal kit per the recipe per the schedule. Also per the schedule, customer party A may travel 205 to meal preparation service provider restaurant party C for service 225 of the prepared meal and where customer party A partakes in dining 226 on the prepared meal.

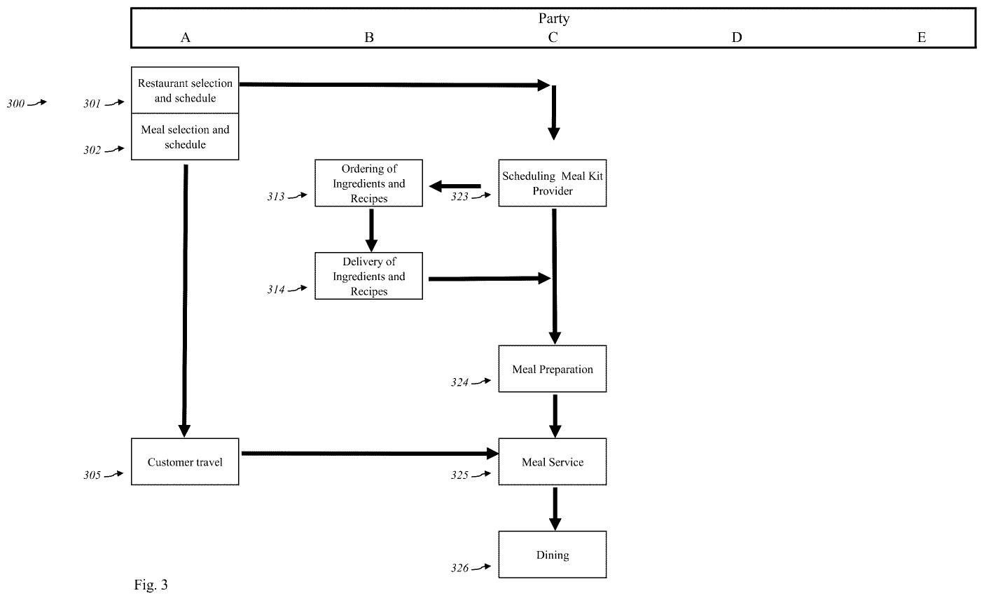

FIG. 3 illustrates a flow chart view of another example of a multi-party restaurant dining meal kit preparation system 300 according to one aspect of the present disclosure. Customer party A may select schedule 301 meal preparation service provider restaurant party C for preparation of the meal and may select a schedule 301 for dining 326 at meal preparation service provider restaurant party C. Customer party A may select 302 a meal and a schedule offered by meal kit company party B. Customer party A may communicate the meal and schedule to meal preparation service provider restaurant party C. Meal preparation service provider restaurant party C may communicate 323 the meal, the restaurant, and the schedule information to meal kit company party B. Meal kit company party B may order 313 the meal kit ingredients and may deliver 314 those meal kit recipe and ingredients to meal preparation service provider restaurant party C per the schedule. Meal preparation service provider restaurant party C may prepare 324 the meal kit per the recipe per the schedule. Also per the schedule, customer party A may travel 305 to meal preparation service provider restaurant party C for service 325 of the prepared meal and where customer party A partakes in dining 326 on the prepared meal.

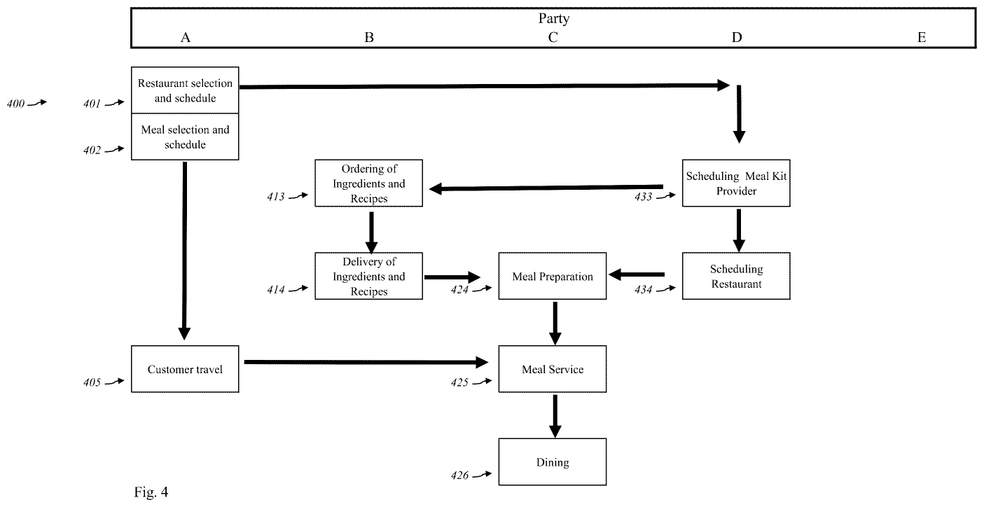

FIG. 4 illustrates a flow chart view of another example of a multi-party restaurant dining meal kit preparation system 400 according to one aspect of the present disclosure. Customer party A may select 401 meal preparation service provider restaurant party C for preparation of the meal and may select 401 a schedule for dining 426 at meal preparation service provider restaurant party C. Customer party A may select 402 a meal and a schedule offered by meal kit company party B. Customer party A may communicate the meal and schedule to a selected scheduling party D. Scheduling party D may communicate 433 the meal, the restaurant, and the schedule information to meal kit company party B and communicate to 434 the meal preparation service provider restaurant party C. Meal kit company party B may order 413 the meal kit ingredients and may deliver 414 those meal kit recipe and ingredients to meal preparation service provider restaurant party C per the schedule. Meal preparation service provider restaurant party C may prepare 424 the meal kit per the recipe per the schedule. Also per the schedule, customer party A may travel 405 to meal preparation service provider restaurant party C for service 425 of the prepared meal and where customer party A partakes in dining 426 on the prepared meal.

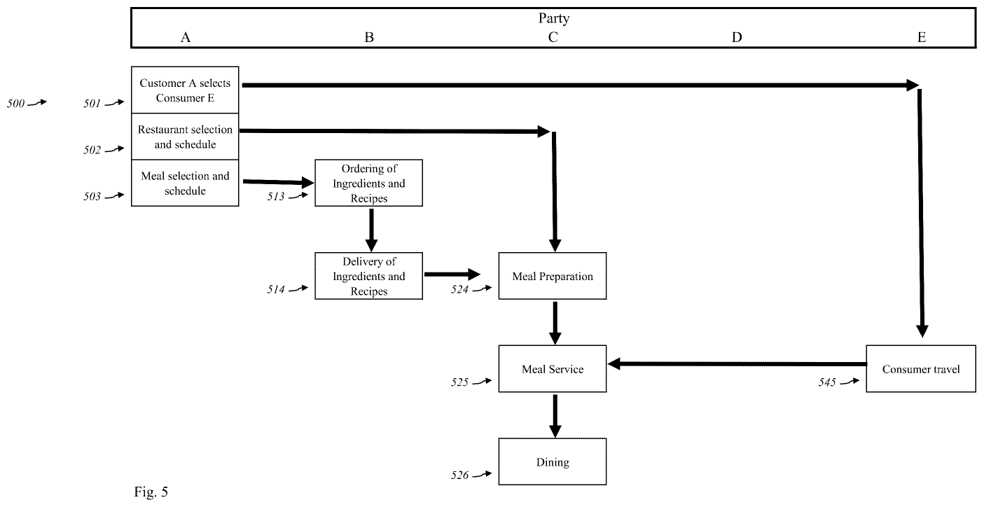

FIG. 5 illustrates a flow chart view of another example of a multi-party restaurant dining meal kit preparation system 500 according to one aspect of the present disclosure. Customer party A may select 501 consumer E as the recipient of the meal and communicate the schedule to consumer E. Customer party A may select meal preparation service provider restaurant party C for preparation of the meal and may select a schedule 502 for dining 526 at meal preparation service provider restaurant party C. Customer party A may select 503 a meal and a schedule offered by meal kit company party B. Customer party A may communicate the meal, the restaurant, and the schedule information to meal kit company party B and restaurant party C. Meal kit company party B may order 513 the meal kit ingredients and may deliver 514 those meal kit recipe and ingredients to meal preparation service provider restaurant party C per the schedule. Meal preparation service provider restaurant party C may prepare 524 the meal kit per the recipe per the schedule. Also per the schedule, the consumer party E may travel 545 to meal preparation service provider restaurant party C for service 525 of the prepared meal and where consumer party E partakes in dining 526 on the prepared meal.

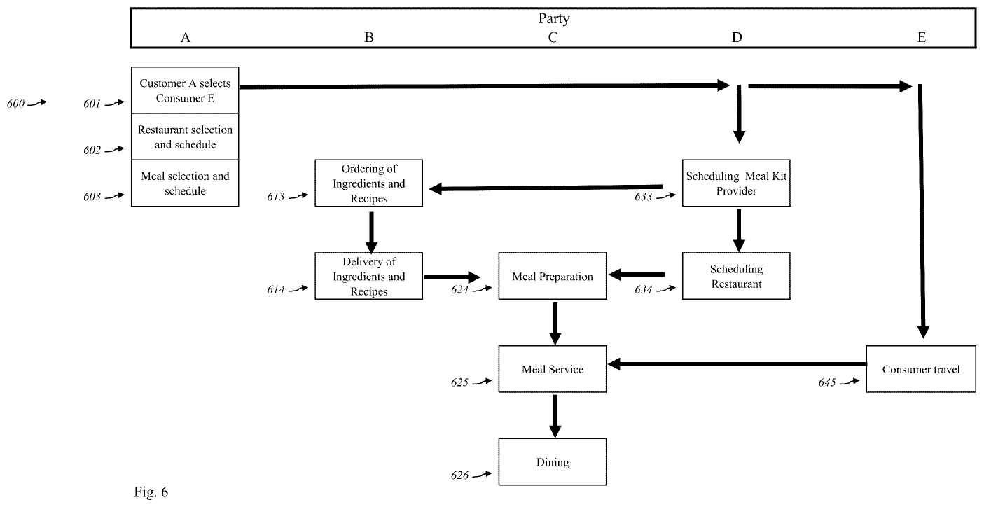

FIG. 6 illustrates a flow chart view of another example of a multi-party restaurant dining meal kit preparation system 600 according to one aspect of the present disclosure. Customer party A may select 601 consumer E to dine on the meal and communicate the meal and schedule to a consumer party E. Customer party A may select 602 meal preparation service provider restaurant party C for preparation of the meal and may select a schedule for dining 626 at meal preparation service provider restaurant party C. Customer party A may select 603 a meal and a schedule offered by meal kit company party B. Customer party A may communicate the meal, the restaurant, and the schedule to a selected scheduling party D. Scheduling party D may communicate 633 the meal and schedule information to meal kit company party B and may communicate 634 the meal and schedule information to meal preparation service provider restaurant party C. Meal kit company party B may order 613 the meal kit ingredients and may deliver 614 those meal kit recipe and ingredients to meal preparation service provider restaurant party C per the schedule. Meal preparation service provider restaurant party C may prepare 624 the meal kit per the recipe per the schedule. Also per the schedule, customer party E may travel 645 to meal preparation service provider restaurant party C for service 625 of the prepared meal and where customer party E partakes in dining 626 on the prepared meal.

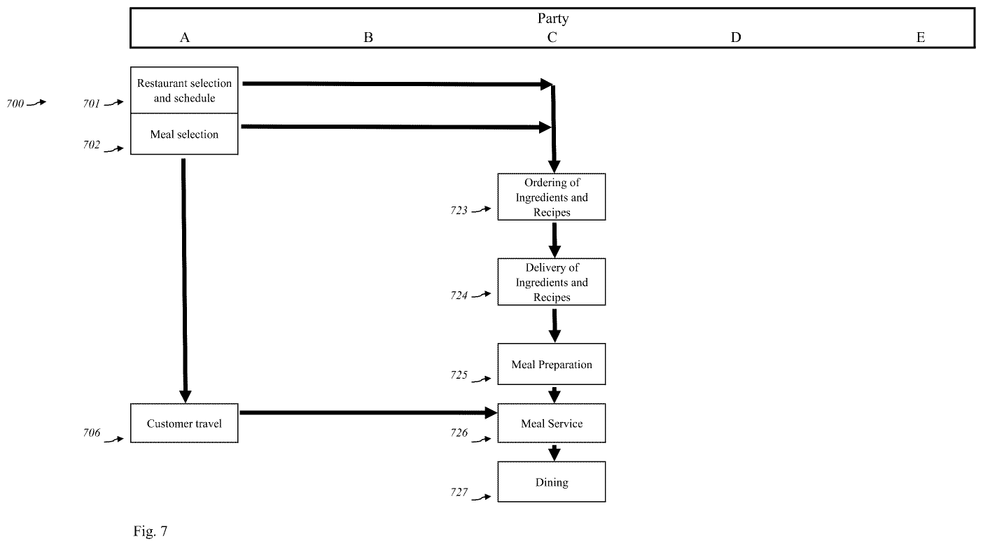

FIG. 7 illustrates a flow chart view of another example of a multi-party restaurant dining meal kit preparation system 700 according to one aspect of the present disclosure. Customer party A may select a meal preparation service provider restaurant party C and a schedule for dining at meal preparation service provider restaurant party C 701, a meal 702, and may communicate the meal and schedule information to meal preparation service provider restaurant party C. Meal preparation service provider restaurant party C may order 723 the meal kit ingredients and may receive delivery 724 of those meal kit recipes and ingredients per the schedule. Meal preparation service provider restaurant party C may prepare 725 the meal kit per the recipe per the schedule. Also per the schedule, customer party A may travel 706 to meal preparation service provider restaurant party C for service 726 of the prepared meal and where customer party A partakes in dining 727 on the prepared meal.

While considerable emphasis has been placed on certain examples, it will be appreciated that many examples can be made and that many changes can be made in the described examples without departing from the principles of the disclosure. For example, in the FIG. 7 example, the Customer party A may select the meal 702 first, and this selection may generate a list of multiple potential meal preparation service provider restaurant parties for subsequent selection. As another example, each of individual system steps may be performed manually or through a computer-assisted process. As another example, a meal preparation service provider restaurant party C may identify particular meal kit recipes on party C's menu. These and other changes in the examples will be apparent to those skilled in the art from this disclosure, where it is distinctly understood that the foregoing descriptive matter is to be interpreted merely as illustrative and not as a limitation.

Although very narrow claims are presented, it should be recognized that the scope of this disclosure is much broader than presented by the claims such as the features specified. It is intended that broader claims will be submitted in an application that claims the benefit of priority from this application.

To the extent that the description above and the accompanying drawings disclose any additional subject matter that is not within the scope of the claims below, the disclosures are not dedicated to the public and the right to file one or more applications to claim such additional disclosures is reserved.

The invention claimed is:

1) A process for food ordering and dining, comprising:
a) a customer party A, a meal kit provider party B, a meal preparation service provider restaurant party C, a location of meal preparation service provider restaurant party C, a scheduling party D, a customer party E, at least one meal kit, and a meal, wherein:
i) the customer party A selects the at least one meal kit, the at least one meal kit comprising ingredients and/or a recipe, from the meal kit provider party B,
ii) the customer party A selects the meal preparation service provider restaurant party C,
iii) the customer party A selects the customer party E to dine on the meal prepared from the at least one meal kit,
iv) the customer party A selects a schedule for the customer party E to dine on the meal,
v) the customer party A communicates the selections of the at least one meal kit, the meal kit provider party B, the meal preparation service provider restaurant party C, the customer party E, and the schedule to the scheduling party D;
vi) the meal kit provider party B delivers the at least one meal kit to the meal preparation service provider restaurant party C;
vii) the meal preparation service provider restaurant party C receives the at least one meal kit from the meal kit provider party B,
viii) the meal preparation service provider restaurant party C prepares the ingredients into the meal according to the meal kit recipe and according to the schedule for the customer party E to dine on the meal;
ix) the scheduling party D orders the at least one meal kit from the meal kit provider party B,
x) the scheduling party D communicates the schedule for preparation of the meal and for the customer party E to dine on the meal at the meal preparation service provider restaurant party C,
xi) the scheduling party D communicates to the customer party E the schedule for the customer party E to dine on the meal; and
xii) the customer party E consumes the meal at the location of the meal preparation service provider restaurant party C according to the schedule for the customer party E to dine on the meal.

2) The process of claim 1 wherein:
a) the scheduling party D is the customer party A.

3) The process of claim 1 wherein:
a) the scheduling party D is the meal kit provider party B.

4) The process of claim 1 wherein:
a) the scheduling party D is the meal preparation service provider restaurant party C.

5) The process of claim 1 wherein:
a) the scheduling party D is the customer party E.

6) The process of claim 1 wherein:
a) the consumer party E is the customer party A.

7) The process of claim 1 wherein:
a) the meal kit provider party B is the meal preparation service provider restaurant party C.

8) The process of claim 1 wherein:
a) the meal kit provider party B is the meal preparation service provider restaurant party C and the meal kit provider party B is also the scheduling party D.

9) The process of claim 1 wherein:
a) the meal kit provider party B is the meal preparation service provider restaurant party C, the meal kit provider party B is also the scheduling party D, and the consumer party E is the customer party A.
